(19) United States
(12) Patent Application Publication
(10) Pub. No.: US 2025/0037064 A1
(43) Pub. Date: Jan. 30, 2025

(54) DATA PROCESSING METHOD AND APPARATUS FOR MATERIAL DELIVERY

(71) Applicants: ZHUZHOU RUIDEER INTELLIGENT EQUIPMENT CO., LTD., Zhuzhou (CN); HUNAN LINGXIN NEW MATERIALS CO., LTD., Changsha (CN)

(72) Inventors: Yingxin Li, Zhuzhou (CN); Zan Liu, Zhuzhou (CN); Kejian Chen, Zhuzhou (CN); Zhihui Luo, Zhuzhou (CN)

(73) Assignees: ZHUZHOU RUIDEER INTELLIGENT EQUIPMENT CO., LTD., Zhuzhou (CN); HUNAN LINGXIN NEW MATERIALS CO., LTD., Changsha (CN)

(21) Appl. No.: 18/716,062

(22) PCT Filed: Dec. 21, 2021
(86) PCT No.: PCT/CN2021/139852

§ 371 Date: Jun. 3, 2024

(30) Foreign Application Priority Data
Dec. 3, 2021 (CN) 202111470764.3

(51) Int. Cl. G06Q 10/083

(52) U.S. Cl. CPC G06Q 10/083

(57) ABSTRACT

A data processing method and an apparatus for material delivery are provided. The method includes: acquiring real-time material border-of-line information; determining whether the real-time material border-of-line information meets a delivery condition to obtain a first determination result; when the first determination result is YES, processing the real-time material border-of-line information by using a preset dynamic material delivery rule to obtain material delivery parameter information; and processing the material delivery parameter information by using a preset delivery instruction generation rule to obtain a delivery instruction set, where the delivery instruction set is used for instructing material delivery.

### CROSS-REFERENCE TO RELATED APPLICATION

This patent application is a national stage of International Application No. PCT/CN2021/139852, filed on Dec. 21, 2021, which claims the benefit and priority of Chinese Patent Application No. 202111470764.3 filed with the China National Intellectual Property Administration on Dec. 3, 2021. Both of the aforementioned applications are hereby incorporated by reference in their entireties.

### TECHNICAL FIELD

The present disclosure relates to the technical field of data processing, in particular to a data processing method and an apparatus for material delivery.

### BACKGROUND

At present, material delivery is usually obtained by processing information such as a material demand and delivery time according to manual statistical data, but it is still difficult to achieve the precise matching between a material demand and material delivery. Therefore, it is particularly important to provide a data processing method and an apparatus for material delivery, so as to achieve the precise matching between a material demand and material delivery, thereby reducing the material delivery cost and improving the operation efficiency.

### SUMMARY

The technical problem to be solved by the present disclosure is to provide a data processing method and an apparatus for material delivery, which can determine the delivery parameter information by determining the real-time material border-of-line information and the delivery condition and comprehensively processing the real-time material border-of-line information by using a dynamic material delivery rule, and generate a delivery instruction for instructing the material delivery, so as to facilitate the precise matching between a material demand and material delivery, thereby reducing the material delivery cost and improving the operation efficiency.

In order to solve the above technical problem, a first aspect of the embodiment of the present disclosure provides a data processing method for material delivery, where the method includes:
acquiring real-time material border-of-line information;
determining whether the real-time material border-of-line information meets a delivery condition to obtain a first determination result:
when the first determination result is YES, processing the real-time material border-of-line information by using a preset dynamic material delivery rule to obtain material delivery parameter information; and
processing the material delivery parameter information by using a preset delivery instruction generation rule to obtain a delivery instruction set: where the delivery instruction set is used for instructing material delivery:

As an alternative embodiment, in the first aspect of the embodiment of the present disclosure, said processing the real-time material border-of-line information by using a preset dynamic material delivery rule to obtain material delivery parameter information includes:
processing the real-time material border-of-line information by using a preset delivery time determination rule to obtain delivery time information:
processing the real-time material border-of-line information by using a preset delivery quantity determination rule to obtain delivery quantity information.

As an alternative embodiment, in the first aspect of the embodiment of the present disclosure, said processing the real-time material border-of-line information by using a preset delivery time determination rule to obtain delivery time information includes: acquiring a border-of-line safety stock value:
processing the border-of-line safety stock value and the real-time material border-of-line information by using a preset first delivery time model to obtain a first delivery time:
processing the real-time material border-of-line information by using a preset second delivery time model to obtain a second delivery time:
processing the first delivery time and the second delivery time by using a preset third delivery time model to obtain delivery time information.

As an alternative embodiment, in the first aspect of the embodiment of the present disclosure, the real-time material border-of-line information includes a delivery cycle and a consumption speed:
said processing the real-time material border-of-line information by using a preset delivery quantity determination rule to obtain delivery quantity information includes:
determining a cycle delivery quantity according to the delivery cycle:
processing the cycle delivery quantity and the consumption speed by using a preset demand correction model to obtain the delivery quantity information.

As an alternative embodiment, in the first aspect of the embodiment of the present disclosure, determining a cycle delivery quantity according to the delivery cycle includes: determining a current total demand according to the delivery cycle:
determining a target quantity model according to the current total demand and a preset quantity solving model:
parsing the target quantity model to obtain the cycle delivery quantity.

As an alternative embodiment, in the first aspect of the embodiment of the present disclosure, the material delivery parameter information includes delivery time information and delivery quantity information:
said processing the material delivery parameter information by using a preset delivery instruction generation rule to obtain a delivery instruction set includes:
acquiring current time information:
determining whether the current time information and the delivery time information meet a time condition to obtain a second determination result:
when the second determination result is YES, determining the delivery instruction set according to the delivery quantity information.

As an alternative embodiment, in the first aspect of the embodiment of the present disclosure, said determining the delivery instruction set according to the delivery quantity information includes:
processing the real-time material border-of-line information to obtain delivery path information:
acquiring delivery vehicle information:
generating a loading instruction according to the delivery vehicle information and the delivery quantity information: where the loading instruction is used for instructing a delivery vehicle to load materials with a quantity matched with the delivery vehicle:
generating a material delivery instruction according to the delivery path information and the delivery vehicle information: where the material delivery instruction is used for instructing the delivery vehicle to deliver the materials to the border-of-line.

A second aspect of the embodiment of the present disclosure provides a data processing apparatus for material delivery, where the apparatus includes:
an acquiring module, which is configured to acquire real-time material border-of-line information;
a determining module, which is configured to determine whether the real-time material border-of-line information meets a delivery condition to obtain a first determination result:
a first processing module, which is configured to, when the first determination result is YES, process the real-time material border-of-line information by using a preset dynamic material delivery rule to obtain material delivery parameter information; and
a second processing module, which is configured to process the material delivery parameter information by using a preset delivery instruction generation rule to obtain a delivery instruction set: where the delivery instruction set is used for instructing material delivery.

As an alternative embodiment, in the second aspect of the embodiment of the present disclosure, the first processing module includes a first processing sub-module and a second processing sub-module, where:
the first processing sub-module is configured to process the real-time material border-of-line information by using a preset delivery time determination rule to obtain delivery time information:
the second processing sub-module is configured to process the real-time material border-of-line information by using a preset delivery quantity determination rule to obtain delivery quantity information.

As an alternative embodiment, in the second aspect of the embodiment of the present disclosure, the first processing sub-module processes the real-time material border-of-line information by using a preset delivery time determination rule to obtain delivery time information, which includes:
acquiring a border-of-line safety stock value:
processing the border-of-line safety stock value and the real-time material border-of-line information by using a preset first delivery time model to obtain a first delivery time:
processing the real-time material border-of-line information by using a preset second delivery time model to obtain a second delivery time:
processing the first delivery time and the second delivery time by using a preset third delivery time model to obtain delivery time information.

As an alternative embodiment, in the second aspect of the embodiment of the present disclosure, the real-time material border-of-line information includes a delivery cycle and a consumption speed:
the second processing sub-module processes the real-time material border-of-line information by using a preset delivery quantity determination rule to obtain delivery quantity information, which includes:
determining a cycle delivery quantity according to the delivery cycle:
processing the cycle delivery quantity and the consumption speed by using a preset demand correction model to obtain delivery quantity information.

As an alternative embodiment, in the second aspect of the embodiment of the present disclosure, the second processing sub-module determines a cycle delivery quantity according to the delivery cycle, which includes:
determining a current total demand according to the delivery cycle:
determining a target quantity model according to the current total demand and a preset quantity solving model:
parsing the target quantity model to obtain the cycle delivery quantity.

As an alternative embodiment, in the second aspect of the embodiment of the present disclosure, the material delivery parameter information includes delivery time information and delivery quantity information:
the second processing module processes the material delivery parameter information by using a preset delivery instruction generation rule to obtain a delivery instruction set, which includes:
acquiring current time information:
determining whether the current time information and the delivery time information meet a time condition to obtain a second determination result:
when the second determination result is YES, determining a delivery instruction set according to the delivery quantity information.

As an alternative embodiment, in the second aspect of the embodiment of the present disclosure, the second processing module determines a delivery instruction set according to the delivery quantity information, which includes:
processing the real-time material border-of-line information to obtain delivery path information:
acquiring delivery vehicle information:
generating a loading instruction according to the delivery vehicle information and the delivery quantity information: where the loading instruction is used for instructing a delivery vehicle to load materials with the quantity matched with the delivery vehicle:
generating a material delivery instruction according to the delivery path information and the delivery vehicle information: where the material delivery instruction is used for instructing the delivery vehicle to deliver materials to the border-of-line.

A third aspect of the present disclosure provides another data processing apparatus for material delivery, where the apparatus includes:
a memory in which an executable program code is stored:
a processor, which is coupled to the memory:
where the processor calls the executable program code stored in the memory to execute part or all of the steps in the data processing method for material delivery provided in the first aspect of the embodiment of the present disclosure.

A fourth aspect of the present disclosure provides a non-transitory computer-readable storage medium, where the non-transitory computer-readable storage medium stores computer instructions which, when called, are used to execute part or all of the steps in the data processing method for material delivery provided in the first aspect of the embodiment of the present disclosure.

Compared with the prior art, the embodiment of the present disclosure has the following beneficial effects.

In the embodiment of the present disclosure, real-time material border-of-line information is acquired: it is determined whether the real-time material border-of-line information meets a delivery condition to obtain a first determination result: when the first determination result is YES, the real-time material border-of-line information is processed by using a preset dynamic material delivery rule to obtain material delivery parameter information; and the material delivery parameter information is processed by using a preset delivery instruction generation rule to obtain a delivery instruction set: where the delivery instruction set is used for instructing material delivery. It can be seen that the delivery parameter information can be determined by determining the real-time material border-of-line information and the delivery condition and comprehensively processing the real-time material border-of-line information by using a dynamic material delivery rule, and a delivery instruction for instructing the material delivery is generated, so as to facilitate the precise matching between a material demand and material delivery, thereby reducing the material delivery cost and improving the operation efficiency.

### BRIEF DESCRIPTION OF THE DRAWINGS

In order to explain the technical scheme in the embodiment of the present disclosure more clearly; the drawings that need to be used in the embodiments will be briefly introduced hereinafter. Obviously, the drawings in the following description are only some embodiments of the present disclosure. For those skilled in the art, other drawings can be obtained according to these drawings without creative labor.

FIG. 1 is a flow schematic diagram of a data processing method for material delivery according to an embodiment of the present disclosure;

FIG. 2 is a flow schematic diagram of another data processing method for material delivery according to an embodiment of the present disclosure:

FIG. 3 is a schematic structural diagram of a data processing apparatus for material delivery according to an embodiment of the present disclosure:

FIG. 4 is a schematic structural diagram of another data processing apparatus for material delivery according to an embodiment of the present disclosure; and

FIG. 5 is a schematic structural diagram of still another data processing apparatus for material delivery according to an embodiment of the present disclosure.

### DETAILED DESCRIPTION OF THE EMBODIMENTS

In order to make those skilled in the art better understand the scheme of the present disclosure, the technical schemes in the embodiments of the present disclosure will be clearly and completely described with reference to the drawings in the embodiments of the present disclosure hereinafter. Obviously, the described embodiments are only some embodiments of the present disclosure, rather than all of the embodiments. Based on the embodiment of the present disclosure, all other embodiments obtained by those skilled in the art without creative labor fall within the scope of protection of the present disclosure.

The terms “first”, “second” and the like in the description and claims of the present disclosure and the above drawings are used to distinguish different objects, rather than describe a specific order. Furthermore, the terms “include” and “have” and any variations thereof are intended to cover non-exclusive inclusion. For example, a process, a method, an apparatus, a product or a device that includes a series of steps or units is not limited to the listed steps or units, but alternatively includes steps or units that are not listed, or alternatively includes other steps or units that are inherent to the process, method, product or device.

Reference to an “embodiment” herein means that a particular feature, structure or characteristic described in connection with the embodiment can be included in at least one embodiment of the present disclosure. The appearance of this phrase in various places in the specification does not necessarily refer to the same embodiment or an independent or alternative embodiment mutually exclusive with other embodiments. It is understood explicitly and implicitly by those skilled in the art that the embodiments described herein can be combined with other embodiments.

The present disclosure provides a data processing method and an apparatus for material delivery, which can determine the delivery parameter information by determining the real-time material border-of-line information and the delivery condition and comprehensively processing the real-time material border-of-line information by using a dynamic material delivery rule, and generate a delivery instruction for instructing the material delivery, so as to facilitate the precise matching between a material demand and material delivery, thereby reducing the material delivery cost and improving the operation efficiency. Detailed description is as follows.

### Embodiment 1

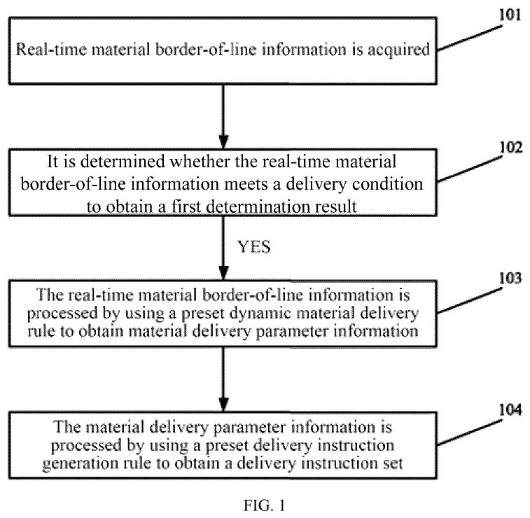

Refer to FIG. 1, which is a flow schematic diagram of a data processing method for material delivery according to an embodiment of the present disclosure. The data processing method for material delivery described in FIG. 1 is applied to a data processing system, such as a local server or a cloud server for data processing and managing for material delivery, which is not limited in the embodiment of the present disclosure. As shown in FIG. 1, the data processing method for material delivery may include the following operation steps 101-104. In step 101, real-time material border-of-line information is acquired.

In step 102, it is determined whether the real-time material border-of-line information meets a delivery condition to obtain a first determination result.

In step 103, when the first determination result is YES, the real-time material border-of-line information is processed by using a preset dynamic material delivery rule to obtain material delivery parameter information.

In step 104, the material delivery parameter information is processed by using a preset delivery instruction generation rule to obtain a delivery instruction set.

In the embodiment of the present disclosure, the delivery instruction set is used for instructing material delivery.

In some embodiments, the above real-time material border-of-line information includes delivery cycle, and/or a consumption speed, and/or a real-time border-of-line quantity, and/or a real-time border-of-line time, which is not limited in the embodiment of the present disclosure.

In some embodiments, the above delivery condition is that the real-time border-of-line quantity is less than or equal to a response stock value.

It can be seen that the implementation of the data processing method for material delivery described in the embodiment of the present disclosure can determine the delivery parameter information through determining the real-time material border-of-line information and the delivery condition and comprehensively processing the real-time material border-of-line information by using a dynamic material delivery rule, and generate a delivery instruction for instructing the material delivery, so as to facilitate the precise matching between a material demand and material delivery, thereby reducing the material delivery cost and improving the operation efficiency.

In an alternative embodiment, in Step 103, the real-time material border-of-line information is processed by using a preset dynamic material delivery rule to obtain material delivery parameter information, which includes following steps:

processing the real-time material border-of-line information by using a preset delivery time determination rule to obtain delivery time information; and

processing the real-time material border-of-line information by using a preset delivery quantity determination rule to obtain delivery quantity information.

It can be seen that the implementation of the data processing method for material delivery described in the embodiment of the present disclosure can process the real-time material border-of-line information by using the delivery time determination rule and the delivery quantity determination rule to obtain the delivery time information and the delivery quantity information, so as to facilitate the precise matching between a material demand and material delivery, thereby reducing the material delivery cost and improving the operation efficiency.

In another alternative embodiment, the real-time material border-of-line information is processed by using a preset delivery time determination rule to obtain delivery time information, which includes following steps:

acquiring a border-of-line safety stock value:

processing the border-of-line safety stock value and the real-time material border-of-line information by using a preset first delivery time model to obtain a first delivery time:

processing the real-time material border-of-line information by using a preset second delivery time model to obtain a second delivery time; and

processing the first delivery time and the second delivery time by using a preset third delivery time model to obtain delivery time information.

In some embodiments, the above border-of-line safety stock value is greater than or equal to the response stock value.

In some embodiments, the first delivery time model is

$${T}_{1} = t + \frac{( Q - S )}{v}$$

where T₁ is a first delivery time, t is a real-time border-of-line time, Q is s real-time border-of-line quantity, S is a border-of-line safety stock value, and v is a consumption speed.

In some embodiments, the second delivery time model is

$${T}_{2} = t + \frac{Q}{v}$$

where T₂ is a second delivery time.

In some embodiments, the third delivery time model is

$${T}_{3} = {T}_{1} - ( \frac{L}{{v}_{c}} - {T}_{f} ) + λ \cdot {T}_{2}$$

where T₃ is a third delivery time, v_{c} is a speed of delivery vehicle, T_{f} is a delivery correction time, λ is a time correction coefficient, and L is a delivery distance.

It can be seen that the implementation of the data processing method for material delivery described in the embodiment of the present disclosure can comprehensively process data information by using the first delivery time model, the second delivery time model and the third delivery time model to obtain delivery time information, so as to facilitate the precise matching between a material demand and material delivery, thereby reducing the material delivery cost and improving the operation efficiency.

In yet another alternative embodiment, the real-time material border-of-line information includes a delivery cycle and a consumption speed.

The real-time material border-of-line information is processed by using a preset delivery quantity determination rule to obtain delivery quantity information, which includes following steps:
determining a cycle delivery quantity according to the delivery cycle; and
processing the cycle delivery quantity and the consumption speed by using a preset demand correction model to obtain delivery quantity information.

In some embodiments, the delivery quantity information includes a delivery quantity, and/or a delivery cycle, and/or material information, which is not limited in the embodiment of the present disclosure.

In some embodiments, the demand correction model is

$${Q}_{p} = {Q}_{d} \cdot v$$

where Qₚ is a delivery quantity, Q_{d} is a cycle delivery quantity, and v is a consumption speed.

It can be seen that the implementation of the data processing method for material delivery described in the embodiment of the present disclosure can determine the cycle delivery quantity according to the delivery cycle, and obtain the delivery quantity information through the further processing of the demand correction model, so as to facilitate the precise matching between a material demand and material delivery, thereby reducing the material delivery cost and improving the operation efficiency.

In another alternative embodiment, a cycle delivery quantity is determined according to the delivery cycle, which includes following steps:
determining a current total demand according to the delivery cycle:
determining a target quantity model according to the current total demand and a preset quantity solving model; and parsing the target quantity model to obtain the cycle delivery quantity.

In the alternative embodiment, as an alternative implementation, the current total demand is determined according to the delivery cycle, which specifically includes following steps:
screening the total demand to be selected which is matched with the delivery cycle from a preset set of the total demand to be selected as the total demand to be used:
processing the real-time border-of-line quantity and the response stock value to obtain the demand correction coefficient; and
processing the demand correction coefficient and the total demand to be used to obtain the current total demand.

In this alternative embodiment, as another alternative implementation, a target quantity model is determined according to the current total demand and a preset quantity solving model, which specifically includes following steps:
inputting the current total demand into the quantity solving model to obtain an objective function; and
inputting the current total demand into a preset constraint model to be used to obtain a target constraint model.

In some embodiments, the quantity solving model is

$$min ( f ) = {Q}_{t} \cdot ( \frac{{C}_{f}}{{Q}_{d}} + {C}_{e} ) + ( \frac{{Q}_{d} + q}{2} + {S}_{s} ) [ {\int }_{0}^{{t}_{t}} ( {C}_{p} \cdot V ) dt + {C}_{r} \cdot V ]$$

In which min(f) is an objective function, Qₜ is a current total demand, C_{f} is a transportation cost, Cₑ is a fuel cost, q is a unit material consumption quantity, Sₛ is a border-of-line safety stock value, tₜ is a production time, Cₚ is a unit volume stock cost, Vis a material volume, and Cᵣ is a risk cost coefficient.

In this alternative embodiment, as another alternative implementation, the target quantity model is parsed to obtain the cycle delivery quantity, which specifically includes following steps:
parsing the target quantity model according to the preset allowance to obtain a delivery quantity interval; and
determining the cycle delivery quantity according to the real-time border-of-line quantity.

It can be seen that the implementation of the data processing method for material delivery described in the embodiment of the present disclosure can obtain the target quantity model by comprehensively processing the delivery cycle, and parse the target quantity model to obtain the cycle delivery quantity; so as to facilitate the precise matching between a material demand and material delivery, thereby reducing the material delivery cost and improving the operation efficiency.

### Embodiment 2

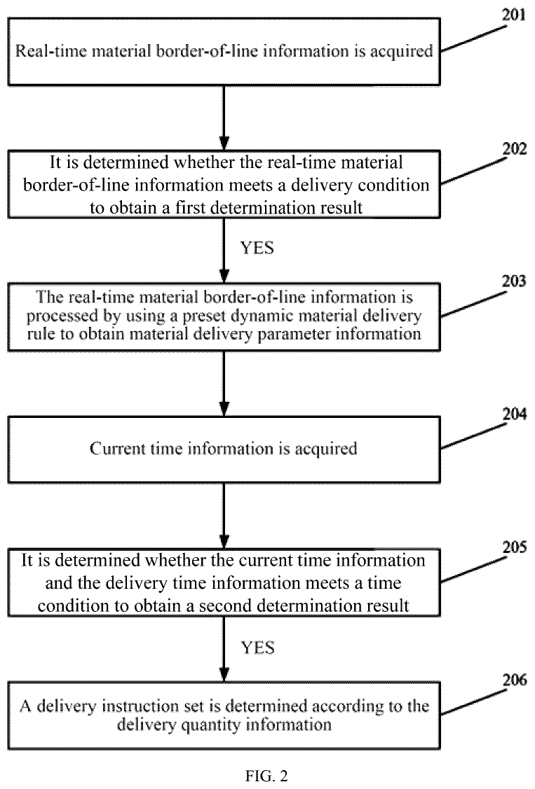

Refer to FIG. 2, which is a flow schematic diagram of another data processing method for material delivery according to an embodiment of the present disclosure. The data processing method for material delivery described in FIG. 2 is applied to a data processing system, such as a local server or a cloud server for data processing and managing for material delivery, which is not limited in the embodiment of the present disclosure. As shown in FIG. 2, the data processing method for material delivery may include the following operation steps 201-206.

In step 201, real-time material border-of-line information is acquired.

In step 202, it is determined whether the real-time material border-of-line information meets a delivery condition to obtain a first determination result.

In step 203, when the first determination result is YES, the real-time material border-of-line information is processed by using a preset dynamic material delivery rule to obtain material delivery parameter information.

In the embodiment of the present disclosure, the material delivery parameter information includes delivery time information and delivery quantity information.

In step 204, current time information is acquired.

In the embodiment of the present disclosure, the current time information includes the current time.

In step 205, it is determined whether the current time information and the delivery time information meet a time condition to obtain a second determination result.

In step 206, when the second determination result is YES, a delivery instruction set is determined according to the delivery quantity information.

In the embodiment of the present disclosure, refer to the detailed description of Step 101 to Step 103 in Embodiment 1 for explanations of the specific technical details and technical terms of Step 201 to Step 203, which will not be described in detail in the embodiment of the present disclosure.

In some embodiments, the delivery time information includes several delivery times.

In some embodiments, the time condition is that the current time is equal to the delivery time.

It can be seen that the implementation of the data processing method for material delivery described in the embodiment of the present disclosure can determine the delivery parameter information by determining the real-time material border-of-line information and the delivery condition and comprehensively processing the real-time material border-of-line information by using a dynamic material delivery rule, and generate a delivery instruction for instructing the material delivery by comprehensively processing the current time information and the material delivery parameter information, so as to facilitate the precise matching between a material demand and material delivery, thereby reducing the material delivery cost and improving the operation efficiency.

In an alternative embodiment, in the above Step 206, a delivery instruction set is determined according to the delivery quantity information, which includes following steps:
processing the real-time material border-of-line information to obtain delivery path information; and
acquiring delivery vehicle information:
generating a loading instruction according to the delivery vehicle information and the delivery quantity information, where the loading instruction is used for instructing a delivery vehicle to load materials with the quantity matched with the delivery vehicle; and
generating a material delivery instruction according to the delivery path information and the delivery vehicle information, where the material delivery instruction is used for instructing the delivery vehicle to deliver materials to the border-of-line.

In this alternative embodiment, the real-time material border-of-line information is processed to obtain delivery path information, which specifically includes following steps:
determining a path objective function and a path constraint condition according to the real-time material border-of-line information:
acquiring a parsing parameter:
processing the parsing parameter, the path objective function and the path constraint condition by using a preset path planning model to obtain path information to be used:
determining whether the path information to be used meets a termination condition to obtain a path determination result; and
when the path determination result is YES, determining the delivery path information according to the path information to be used.

In some embodiments, the path planning model is an artificial intelligence model based on the dynamic step-based Fruit Fly Optimization Algorithm.

In some embodiments, the path information to be used includes the current optimal path information, and/or the number of iterations, and/or an iteration error, which is not limited in the embodiment of the present disclosure.

In some embodiments, the parsing parameter includes an error threshold, and/or an iteration threshold, and/or a population size, and/or an upper penalty coefficient, and/or a lower penalty coefficient, and/or a time window satisfaction rate, which is not limited in the embodiment of the present disclosure.

In some embodiments, whether the path information to be used meets a termination condition is determined to obtain a path determination result, which specifically includes following steps:
determining whether the iterative error is less than or equal to the error threshold to obtain an error determination result:
in which, when the error determination result is YES, the path determination result is YES:
in which, when the error determination result is NO, determining whether the number of iterations is equal to the iteration threshold to obtain an iteration determination result:
in which, when the iterative determination result is YES, the path determination result is YES.

It can be seen that the implementation of the data processing method for material delivery described in the embodiment of the present disclosure can obtain the loading instruction and the material delivery instruction by comprehensive processing the real-time material border-of-line information, the delivery vehicle information and the delivery quantity information, so as to facilitate the precise matching between a material demand and material delivery, thereby reducing the material delivery cost and improving the operation efficiency.

### Embodiment 3

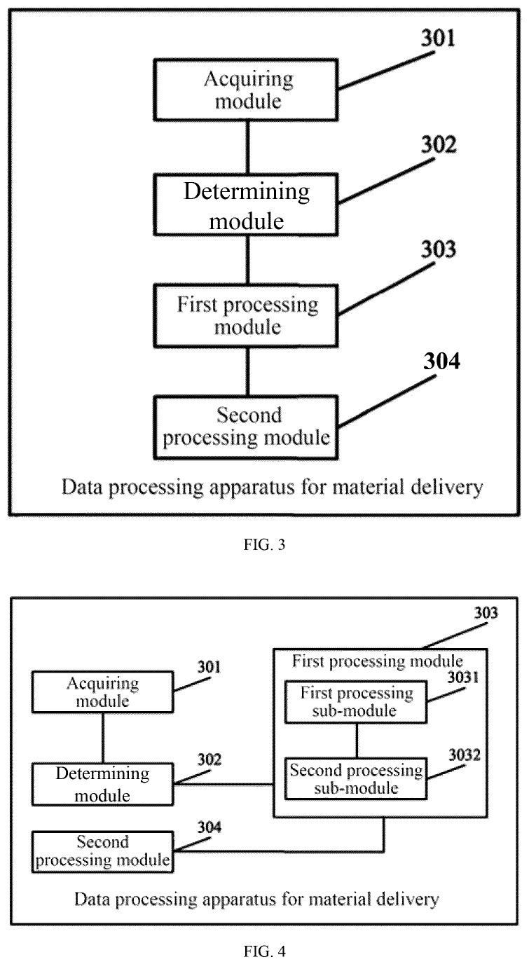

Refer to FIG. 3, which is a schematic structural diagram of a data processing apparatus for material delivery according to an embodiment of the present disclosure. The apparatus described in FIG. 3 can be applied to a data processing system, such as a local server or a cloud server for data processing and managing for material delivery, which is not limited in the embodiment of the present disclosure. As shown in FIG. 3, the apparatus may include an acquiring module 301, a determining module 302, a first processing module 303, a second processing module 304.

The acquiring module 301 is configured to acquire real-time material border-of-line information.

The determining module 302 is configured to determine whether the real-time material border-of-line information meets a delivery condition to obtain a first determination result.

The first processing module 303 is configured to, when the first determination result is YES, process the real-time material border-of-line information by using a preset dynamic material delivery rule to obtain material delivery parameter information.

The second processing module 304 is configured to process the material delivery parameter information by using a preset delivery instruction generation rule to obtain a delivery instruction set: where the delivery instruction set is used for instructing material delivery.

It can be seen that the implementation of the data processing apparatus for material delivery described in FIG. 3 can determine the delivery parameter information by determining the real-time material border-of-line information and the delivery condition and comprehensively processing the real-time material border-of-line information by using a dynamic material delivery rule, and generate a delivery instruction for instructing the material delivery, so as to facilitate the precise matching between a material demand and material delivery, thereby reducing the material delivery cost and improving the operation efficiency.

In another alternative embodiment, as shown in FIG. 4, the first processing module 303 includes a first processing sub-module 3031 and a second processing sub-module 3032, where:
the first processing sub-module 3031 is configured to process the real-time material border-of-line information by using a preset delivery time determination rule to obtain delivery time information; and
the second processing sub-module 3032 is configured to process the real-time material border-of-line information by using a preset delivery quantity determination rule to obtain delivery quantity information.

It can be seen that the implementation of the data processing apparatus for material delivery described in FIG. 4 can process the real-time material border-of-line information by using the delivery time determination rule and the delivery quantity determination rule to obtain the delivery time information and the delivery quantity information, so as to facilitate the precise matching between a material demand and material delivery, thereby reducing the material delivery cost and improving the operation efficiency.

In another alternative embodiment, as shown in FIG. 4, the first processing sub-module 3031 processes the real-time material border-of-line information by using a preset delivery time determination rule to obtain delivery time information, which specifically includes following steps:
acquiring a border-of-line safety stock value:
processing the border-of-line safety stock value and the real-time material border-of-line information are processed by using a preset first delivery time model to obtain a first delivery time:
processing the real-time material border-of-line information by using a preset second delivery time model to obtain a second delivery time; and
processing the first delivery time and the second delivery time by using a preset third delivery time model to obtain delivery time information.

It can be seen that the implementation of the data processing apparatus for material delivery described in FIG. 4 can comprehensively process data information by using the first delivery time model, the second delivery time model and the third delivery time model to obtain delivery time information, so as to facilitate the precise matching between a material demand and material delivery, thereby reducing the material delivery cost and improving the operation efficiency:

In yet another alternative embodiment, as shown in FIG. 4, the real-time material border-of-line information includes a delivery cycle and a consumption speed.

The second processing sub-module 3032 processes the real-time material border-of-line information by using a preset delivery quantity determination rule to obtain delivery quantity information, which specifically includes following steps:
determining a cycle delivery quantity according to the delivery cycle; and
processing the cycle delivery quantity and the consumption speed by using a preset demand correction model to obtain delivery quantity information.

It can be seen that the implementation of the data processing apparatus for material delivery described in FIG. 4 can determine the cycle delivery quantity according to the delivery cycle, and obtain the delivery quantity information through the further processing of the demand correction model, so as to facilitate the precise matching between a material demand and material delivery, thereby reducing the material delivery cost and improving the operation efficiency.

In another alternative embodiment, as shown in FIG. 4, the second processing sub-module 3032 determines a cycle delivery quantity according to the delivery cycle, which includes following steps:
determining a current total demand according to the delivery cycle:
determining a target quantity model according to the current total demand and a preset quantity solving model; and parsing the target quantity model to obtain the cycle delivery quantity.

It can be seen that the implementation of the data processing apparatus for material delivery described in FIG. 4 can obtain the target quantity model by comprehensively processing the delivery cycle, and parse the target quantity model to obtain the cycle delivery quantity, so as to facilitate the precise matching between a material demand and material delivery, thereby reducing the material delivery cost and improving the operation efficiency.

In yet another alternative embodiment, as shown in FIG. 4, the material delivery parameter information includes delivery time information and delivery quantity information:
the second processing module 304 processes the material delivery parameter information by using a preset delivery instruction generation rule to obtain a delivery instruction set, which specifically includes following steps:
acquiring current time information:
determining whether the current time information and the delivery time information meet a time condition to obtain a second determination result; and
when the second determination result is YES, determining a delivery instruction set according to the delivery quantity information.

It can be seen that the implementation of the data processing apparatus for material delivery described in FIG. 4 can determine the delivery parameter information by determining the real-time material border-of-line information and the delivery condition and comprehensively processing the real-time material border-of-line information by using a dynamic material delivery rule, and generate a delivery instruction for instructing the material delivery by comprehensively processing the current time information and the material delivery parameter information, so as to facilitate the precise matching between a material demand and material delivery, thereby reducing the material delivery cost and improving the operation efficiency:

In another alternative embodiment, as shown in FIG. 4, the second processing module 304 determines a delivery instruction set according to the delivery quantity information, which specifically includes following steps:
processing the real-time material border-of-line information to obtain delivery path information:
acquiring delivery vehicle information:
generating a loading instruction according to the delivery vehicle information and the delivery quantity information: where the loading instruction is used for instructing a delivery vehicle to load materials with the quantity matched with the delivery vehicle; and
generating a material delivery instruction according to the delivery path information and the delivery vehicle information: where the material delivery instruction is used for instructing the delivery vehicle to deliver materials to the border-of-line.

It can be seen that the implementation of the data processing apparatus for material delivery described in FIG. 4 can obtain the loading instruction and the material delivery instruction by comprehensive processing the real-time material border-of-line information, the delivery vehicle information and the delivery quantity information, so as to facilitate the precise matching between a material demand and material delivery, thereby reducing the material delivery cost and improving the operation efficiency.

### Embodiment 4

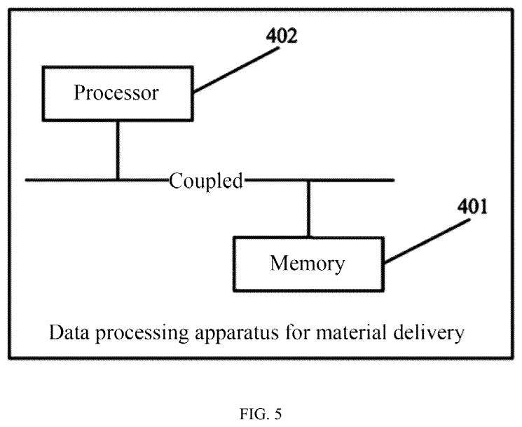

Refer to FIG. 5, which is a schematic structural diagram of another data processing apparatus for material delivery according to an embodiment of the present disclosure. The apparatus described in FIG. 5 can be applied to a data processing system, such as a local server or a cloud server for data processing and managing for material delivery, which is not limited in the embodiment of the present disclosure. As shown in FIG. 5, the apparatus may include a memory 401 and a processor 402.

An executable program code is stored on the memory 401.

The processor 402 is coupled to the memory 401.

The processor 402 calls the executable program code stored in the memory 401 to execute the steps in the data processing method for material delivery described in Embodiment 1 or Embodiment 2.

### Embodiment 5

The embodiment of the present disclosure provides a non-transitory computer-readable storage medium, which stores a computer program for electronic data exchange, where the computer program causes a computer to execute the steps in the data processing method for material delivery described in Embodiment 1 or Embodiment 2.

### Embodiment 6

The embodiment of the present disclosure provides a computer program product. The computer program product includes a non-transitory computer-readable storage medium in which a computer program is stored, and the computer program is operable to cause a computer to execute the steps in the data processing method for material delivery described in Embodiment 1 or Embodiment 2.

The apparatus embodiments described above are only schematic, in which the modules described as separate components may or may not be physically separated, and the components displayed as modules may or may not be physical modules. That is, the components may be located in one place, or may be distributed to a plurality of network modules. Some or all of the modules can be selected according to actual needs to achieve the purpose of this embodiment. Those skilled in the art can understand and implement the purpose without creative labor.

Through the detailed description of the above embodiments, those skilled in the art can clearly understand that each embodiment can be realized by a software plus necessary general hardware platform, and of course can also be realized by hardware. Based on this understanding, the essence of the above technical scheme or the part that has contributed to the prior art can be embodied in the form of a software product. The computer software product can be stored in a computer-readable storage medium. The storage medium includes a Read-Only Memory (ROM), a Random Access Memory (RAM), a Programmable Read-only Memory (PROM), an Erasable Programmable Read-Only Memory (EPROM), an One-time Programmable Read-Only Memory (OTPROM), an Electrically Erasable Programmable Read-Only Memory (EEPROM), a Compact Disc Read-Only Memory (CD-ROM) or other optical disc storages. magnetic disk storages, magnetic tape storages, or any other computer-readable medium that can be used to carry or store data.

Finally, it should be explained that a data processing method and an apparatus for material delivery according to an embodiment of the present disclosure only explain a preferable embodiment of the present disclosure, which is only used to illustrate the technical scheme of the present disclosure, rather than limit the technical scheme. Although the present disclosure has been described in detail with reference to the foregoing embodiments, it should be understood by those skilled in the art that the technical scheme described in the above embodiments can still be modified, or some technical features can be substituted equivalently. However, these modifications or substitutions do not make the essence of the corresponding technical scheme deviate from the spirit and scope of the technical scheme of various embodiments of the present disclosure.

What is claimed is:

1. A data processing method for material delivery, wherein the method comprises:
acquiring real-time material border-of-line information;
determining whether the real-time material border-of-line information meets a delivery condition to obtain a first determination result;
when the first determination result is YES, processing the real-time material border-of-line information by using a preset dynamic material delivery rule to obtain material delivery parameter information; and
processing the material delivery parameter information by using a preset delivery instruction generation rule to obtain a delivery instruction set; wherein the delivery instruction set is used for instructing material delivery.

2. The data processing method for material delivery according to claim 1, wherein said processing the real-time material border-of-line information by using a preset dynamic material delivery rule to obtain material delivery parameter information comprises:
processing the real-time material border-of-line information by using a preset delivery time determination rule to obtain delivery time information;
processing the real-time material border-of-line information by using a preset delivery quantity determination rule to obtain delivery quantity information.

3. The data processing method for material delivery according to claim 2, wherein said processing the real-time material border-of-line information by using a preset delivery time determination rule to obtain delivery time information comprises:
acquiring a border-of-line safety stock value;
processing the border-of-line safety stock value and the real-time material border-of-line information by using a preset first delivery time model to obtain a first delivery time;
processing the real-time material border-of-line information by using a preset second delivery time model to obtain a second delivery time;
processing the first delivery time and the second delivery time by using a preset third delivery time model to obtain delivery time information.

4. The data processing method for material delivery according to claim 2, wherein the real-time material border-of-line information comprises a delivery cycle and a consumption speed;
said processing the real-time material border-of-line information by using a preset delivery quantity determination rule to obtain delivery quantity information comprises:
determining a cycle delivery quantity according to the delivery cycle;
processing the cycle delivery quantity and the consumption speed by using a preset demand correction model to obtain the delivery quantity information.

5. The data processing method for material delivery according to claim 4, wherein determining a cycle delivery quantity according to the delivery cycle comprises:
determining a current total demand according to the delivery cycle;
determining a target quantity model according to the current total demand and a preset quantity solving model;
parsing the target quantity model to obtain the cycle delivery quantity.

6. The data processing method for material delivery according to claim 1, wherein the material delivery parameter information comprises delivery time information and delivery quantity information;
said processing the material delivery parameter information by using a preset delivery instruction generation rule to obtain a delivery instruction set comprises:
acquiring current time information;
determining whether the current time information and the delivery time information meet a time condition to obtain a second determination result;
when the second determination result is YES, determining the delivery instruction set according to the delivery quantity information.

7. The data processing method for material delivery according to claim 6, wherein said determining the delivery instruction set according to the delivery quantity information comprises:
processing the real-time material border-of-line information to obtain delivery path information;
acquiring delivery vehicle information;
generating a loading instruction according to the delivery vehicle information and the delivery quantity information; wherein the loading instruction is used for instructing a delivery vehicle to load materials with a quantity matched with the delivery vehicle;
generating a material delivery instruction according to the delivery path information and the delivery vehicle information; wherein the material delivery instruction is used for instructing the delivery vehicle to deliver the materials to the border-of-line.

8. A data processing apparatus for material delivery, wherein the apparatus comprises:
an acquiring module, which is configured to acquire real-time material border-of-line information;
a determining module, which is configured to determine whether the real-time material border-of-line information meets a delivery condition to obtain a first determination result;
a first processing module, which is configured to, when the first determination result is YES, process the real-time material border-of-line information by using a preset dynamic material delivery rule to obtain material delivery parameter information; and
a second processing module, which is configured to process the material delivery parameter information by using a preset delivery instruction generation rule to obtain a delivery instruction set; wherein the delivery instruction set is used for instructing material delivery.

9. A data processing apparatus for material delivery, wherein the apparatus comprises:
a memory in which an executable program code is stored;
a processor, which is coupled to the memory;
wherein the processor calls the executable program code stored in the memory to execute the data processing method for material delivery according to claim 1.

10. A
non-transitory computer-readable storage medium, wherein the non-transitory computer-readable storage medium stores computer instructions which, when called, are used to execute the data processing method for material delivery according to claim 1.

11. The data processing apparatus for material delivery according to claim 9, wherein said processing the real-time material border-of-line information by using a preset dynamic material delivery rule to obtain material delivery parameter information comprises:
processing the real-time material border-of-line information by using a preset delivery time determination rule to obtain delivery time information;
processing the real-time material border-of-line information by using a preset delivery quantity determination rule to obtain delivery quantity information.

12. The data processing apparatus for material delivery according to claim 11, wherein said processing the real-time material border-of-line information by using a preset delivery time determination rule to obtain delivery time information comprises:
acquiring a border-of-line safety stock value;
processing the border-of-line safety stock value and the real-time material border-of-line information by using a preset first delivery time model to obtain a first delivery time;
processing the real-time material border-of-line information by using a preset second delivery time model to obtain a second delivery time;
processing the first delivery time and the second delivery time by using a preset third delivery time model to obtain delivery time information.

13. The data processing apparatus for material delivery according to claim 11, wherein the real-time material border-of-line information comprises a delivery cycle and a consumption speed;
said processing the real-time material border-of-line information by using a preset delivery quantity determination rule to obtain delivery quantity information comprises:
determining a cycle delivery quantity according to the delivery cycle;
processing the cycle delivery quantity and the consumption speed by using a preset demand correction model to obtain the delivery quantity information.

14. The data processing apparatus for material delivery according to claim 13, wherein determining a cycle delivery quantity according to the delivery cycle comprises:
determining a current total demand according to the delivery cycle;
determining a target quantity model according to the current total demand and a preset quantity solving model;
parsing the target quantity model to obtain the cycle delivery quantity.

15. The data processing apparatus for material delivery according to claim 9, wherein the material delivery parameter information comprises delivery time information and delivery quantity information;
said processing the material delivery parameter information by using a preset delivery instruction generation rule to obtain a delivery instruction set comprises:
acquiring current time information;
determining whether the current time information and the delivery time information meet a time condition to obtain a second determination result;
when the second determination result is YES, determining the delivery instruction set according to the delivery quantity information.

16. The data processing apparatus for material delivery according to claim 15, wherein said determining the delivery instruction set according to the delivery quantity information comprises:
processing the real-time material border-of-line information to obtain delivery path information;
acquiring delivery vehicle information;
generating a loading instruction according to the delivery vehicle information and the delivery quantity information; wherein the loading instruction is used for instructing a delivery vehicle to load materials with a quantity matched with the delivery vehicle;
generating a material delivery instruction according to the delivery path information and the delivery vehicle information; wherein the material delivery instruction is used for instructing the delivery vehicle to deliver the materials to the border-of-line.

17. The non-transitory computer-readable storage medium according to claim 10, wherein said processing the real-time material border-of-line information by using a preset dynamic material delivery rule to obtain material delivery parameter information comprises:
processing the real-time material border-of-line information by using a preset delivery time determination rule to obtain delivery time information;
processing the real-time material border-of-line information by using a preset delivery quantity determination rule to obtain delivery quantity information.

18. The non-transitory computer-readable storage medium according to claim 17, wherein said processing the real-time material border-of-line information by using a preset delivery time determination rule to obtain delivery time information comprises:
acquiring a border-of-line safety stock value;
processing the border-of-line safety stock value and the real-time material border-of-line information by using a preset first delivery time model to obtain a first delivery time;
processing the real-time material border-of-line information by using a preset second delivery time model to obtain a second delivery time;
processing the first delivery time and the second delivery time by using a preset third delivery time model to obtain delivery time information.

19. The non-transitory computer-readable storage medium according to claim 17, wherein the real-time material border-of-line information comprises a delivery cycle and a consumption speed;
said processing the real-time material border-of-line information by using a preset delivery quantity determination rule to obtain delivery quantity information comprises:
determining a cycle delivery quantity according to the delivery cycle;
processing the cycle delivery quantity and the consumption speed by using a preset demand correction model to obtain the delivery quantity information.

20. The non-transitory computer-readable storage medium according to claim 19, wherein determining a cycle delivery quantity according to the delivery cycle comprises:
determining a current total demand according to the delivery cycle;
determining a target quantity model according to the current total demand and a preset quantity solving model;
parsing the target quantity model to obtain the cycle delivery quantity.
